(19) United States
(12) Patent Application Publication
(10) Pub. No.: US 2019/0146802 A1
(43) Pub. Date: May 16, 2019

(54) INFORMATION PROCESSING APPARATUS, ARITHMETIC PROCESSING APPARATUS, AND CONTROL METHOD FOR INFORMATION PROCESSING APPARATUS

(71) Applicant: FUJITSU LIMITED, Kawasaki-shi (JP)

(72) Inventor: Masahiro Kuramoto, Kawasaki (JP)

(73) Assignee: FUJITSU LIMITED, Kawasaki-shi (JP)

(21) Appl. No.: 16/167,587

(22) Filed: Oct. 23, 2018

(30) Foreign Application Priority Data
Nov. 10, 2017 (JP) 2017-217025

(51) Int. Cl. G06F 9/38; G06F 9/28; G06F 9/30; G06F 13/36

(52) U.S. Cl. CPC G06F 9/3897; G06F 13/36; G06F 9/30141; G06F 9/28

(57) ABSTRACT

An information processing apparatus includes a plurality of arithmetic processing apparatuses each of which is coupled to a first plurality of other arithmetic processing apparatuses among the plurality of arithmetic processing apparatuses via a first path and a second path, to a second plurality of other arithmetic processing apparatuses among the plurality of arithmetic processing apparatuses via a third path. Each of the plurality of arithmetic processing apparatuses includes first positional information on the first path, second positional information on the second path, and third positional information on the third path. Each of the plurality of arithmetic processing apparatuses performs a communication with the first plurality of other arithmetic processing apparatuses or the second plurality of other arithmetic processing apparatuses using address information in which the first positional information and the second positional information corresponding to each of the first plurality of other arithmetic processing apparatuses are identical.

### CROSS-REFERENCE TO RELATED APPLICATION

This application is based upon and claims the benefit of priority of the prior Japanese Patent Application No. 2017-217025, filed on Nov. 10, 2017, the entire contents of which are incorporated herein by reference.

### FIELD

The embodiments discussed herein are related to an information processing apparatus, an arithmetic processing apparatus, and a control method for an information processing apparatus.

### BACKGROUND

When a large-scale calculation such as a scientific technology calculation is performed using a computer system, a parallel calculation using a plurality of calculators is performed. An information processing apparatus capable of performing the parallel calculation is called a parallel computer. For example, the parallel computer includes a plurality of processors, and each process operating on each of the processors performs an overall calculation process while communicating data between the processes, thereby implementing a high arithmetic performance. A computational resource in the parallel computer, such as a processor, is called a node.

The parallel computer includes an inter-node connection network in which nodes are connected to each other via the Interconnect. In the inter-node connection network, it is general to use a direct network that uses an interconnect of connecting nodes each other. As a connection topology of a direct network which connects tens of thousands of nodes in a super parallel computer, a multidimensional mesh or a multidimensional torus is generally used.

Each node includes multiple connection ports. The inter-node connection may be grasped as a configuration in which coordinates are assigned to each connection port. For example, when a node includes six connection ports, it may be grasped that two connection ports represent the positive/negative direction of an X axis, the other two connection ports represent the positive/negative direction of a Y axis, and the remaining two connection ports represent the positive/negative direction of a Z axis. In this case, the connection port in the positive direction of the X axis is connected to the connection port in the negative direction of the X axis of the other node. By connecting the positive direction and the negative direction of the X axis, the X axis is represented by a connection path in which a plurality of nodes are continuously connected. Similarly, by connecting the positive direction and the negative direction of the Y axis, the Y axis is represented by a connection path in which a plurality of nodes are continuously connected, and by connecting the positive direction and the negative direction of the Z axis, the Z axis is represented by a connection path in which a plurality of nodes are continuously connected. That is, the parallel computer includes a three-dimensional inter-node connection network.

In the case of a high-dimensional connection, each node is assigned, for example, with an address represented by each coordinate. For example, in a three-dimensional inter-node network, an address expressed in three-dimensional coordinates (X, Y, Z) is assigned to each node. Then, as the address of each node advances in the positive direction of each coordinate, the value of the coordinate is added. Conversely, as the address of each node advances in the positive direction of each coordinate, the address of each node is subtracted from the value of the coordinate.

When an inter-node communication is performed, a source node transmits a packet adopting the address of a destination node as a destination address. The node that has received the packet compares the destination address with the own address, and when the destination address does not match the own address, the node that has received the packet transmits the packet to the other node. When the destination address matches the own address, the node processes the received packet as the own packet.

Since many nodes are connected in a high-dimensional connection in a packet routing method, each nodes does not have a routing table. Instead, there is a method of determining which connection port is used as an output port according to each node rule.

For example, as a technology of inter-node connection, in an inter-node connection having a connection topology of a three-dimensional torus, communication between nodes is carried out by the wavelength multiplexing, and the degree of multiplexing is changed to increase or decrease the communication capacity of individual transmission paths.

Related technologies are disclosed in, for example, Japanese Laid-open Patent Publication No. 2006-215815.

### SUMMARY

According to an aspect of the embodiments, an information processing apparatus includes a plurality of arithmetic processing apparatuses each of the plurality of arithmetic processing apparatuses is coupled to a first plurality of other arithmetic processing apparatuses among the plurality of arithmetic processing apparatuses via a first path and a second path, each of the plurality of arithmetic processing apparatuses is coupled to a second plurality of other arithmetic processing apparatuses among the plurality of arithmetic processing apparatuses via a third path, each of the plurality of arithmetic processing apparatuses includes first positional information on the first path, second positional information on the second path, and third positional information on the third path. Each of the plurality of arithmetic processing apparatuses performs a communication with the first plurality of other arithmetic processing apparatuses or the second plurality of other arithmetic processing apparatuses using address information in which the first positional information and the second positional information corresponding to each of the first plurality of other arithmetic processing apparatuses are identical.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the state of an inter-node connection of calculators in a parallel computer;

FIG. 2 is a diagram illustrating a connection port of the calculator;

FIG. 3 is a diagram illustrating a state in which the coordinate axes are integrated when a multi-port structure is provided;

FIG. 4 is a block diagram of the calculator;

FIG. 5 is a flowchart of a transmission process of a packet by a parallel computer according to a first embodiment;

FIG. 6 is a block diagram of a management system of a parallel computer according to a second embodiment;

FIG. 7 is a flowchart of a process of determining a connection path;

FIGS. 8A and 8B are flowcharts of an address assignment process;

FIG. 9 is a diagram illustrating a priority order pattern;

FIG. 10 is a flowchart of a packet transmission process by the parallel computer according to a third embodiment;

FIG. 11 is a block diagram of a calculator according to a fourth embodiment;

FIG. 12 is a flowchart of a packet transmission process by the parallel computer according to the fourth embodiment; and

FIG. 13 is a diagram for explaining transmission and reception of packets in a parallel computer according to a fifth embodiment.

### DESCRIPTION OF EMBODIMENTS

In a parallel computer of the related art, all the buses are connected with the same performance. For this reason, when there is a route on which communication is frequently performed, there is a possibility that the bus bandwidth on the route is insufficient. Therefore, it is considered that multiplexing is performed using another route in order to solve the bandwidth shortage. However, when another route is used, a process such as creating a protocol that expresses the order guarantee or redundancy may be added, and there is a possibility that the latency may vary for each route.

In addition, when a plurality of buses are simply used as routes for the same dimension, it may be difficult to represent a single node with a single address. When a plurality of addresses is assigned to one node, for example, in order to connect a bus to a node that uses a bus as in the related art, a plurality of address expressions is represented such that each node is connected via a different route. As a result, the assignment of addresses may be complicated. In addition, when assigning the plurality of addresses to a single node, management of addresses may become troublesome in the software or hardware that requests a transmission of packets.

For these reasons, it has been difficult to speed up the bus designated as the route on which frequent communication is performed. Therefore, it has been difficult to improve the processing speed of the parallel computer.

Embodiments of an information processing apparatus, an arithmetic processing apparatus, and a control method of the information processing apparatus according to the present disclosure will be described in detail below with reference to the accompanying drawings. The embodiments described below do not limit the information processing apparatus, the arithmetic processing apparatus, and the control method of the information processing apparatus disclosed herein.

### First Embodiment

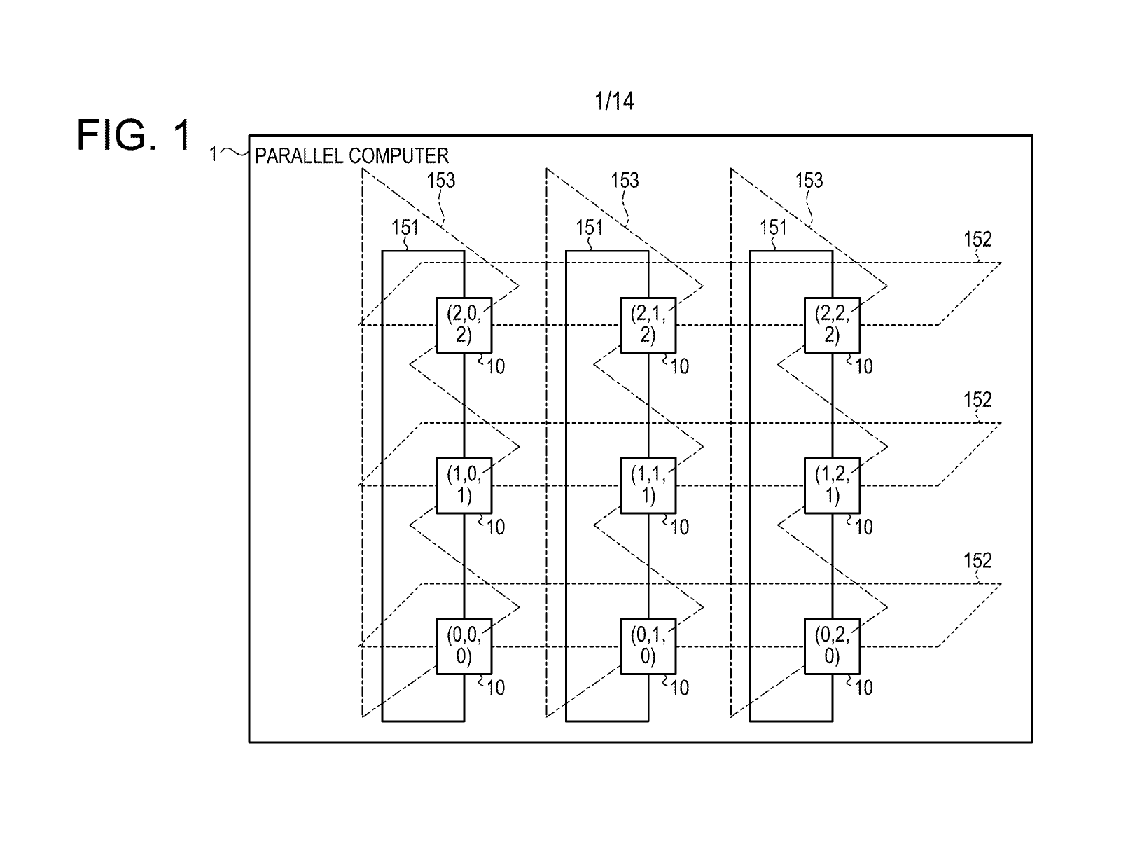

FIG. 1 is a diagram illustrating the state of an inter-node connection of calculators in a parallel computer. As illustrated in FIG. 1, a parallel computer 1, which is an information processing apparatus according to the present embodiment, includes nine calculators 10 which are arithmetic processing apparatuses. Here, the number of the calculators 10 of the parallel computer 1 is not particularly limited.

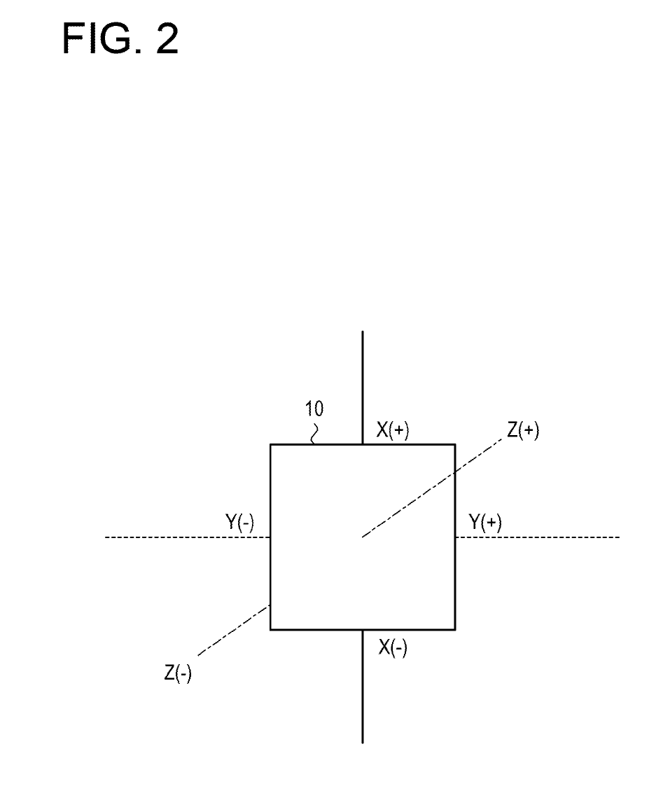

Each calculator 10 has six connection ports as illustrated in FIG. 2. FIG. 2 is a diagram illustrating a connection port of the calculator. As illustrated in FIG. 2, paths to which the connection ports of the calculator 10 according to the present embodiment are connected are represented as the X axis, the Y axis, and the Z axis, respectively.

As illustrated in FIG. 2, one of the connection ports of the calculator 10 is connected to a path extending in the positive direction of the X axis represented by X(+), and the other is connected to a path extending in the negative direction of the X axis represented by X(−). That is, one of the combinations of two connection ports of the calculator 10 becomes a portion of a path representing the X axis. Further, one of the connection ports of the calculator 10 is connected to a path extending in the positive direction of the Y axis represented by Y(+), and the other is connected to a path extending in the negative direction of the Y axis represented by Y(−). That is, one of the combinations of two connection ports of the calculator 10 becomes a portion of a path representing the Y axis. In addition, one of the connection ports of the calculator 10 is connected to a path extending in the positive direction of the Z axis represented by Z(+), and the other is connected to a path extending in the negative direction of the Z axis represented by Z(−). That is, one of the combinations of two connection ports of the calculator 10 becomes a portion of a path representing the Z axis.

The connection port extending in the positive direction of the X axis of the calculator 10 is connected to the connection port extending in the negative direction of the X axis of the other calculator 10. Further, the connection port extending in the positive direction of the Y axis of the calculator 10 is connected to the connection port extending in the negative direction of the Y axis of the other calculator 10. The connection port extending in the positive direction of the Z axis of the calculator 10 is connected to the connection port extending in the negative direction of the Z axis of the other calculator 10. Furthermore, in the parallel computer 1 according to the present embodiment, the calculator 10 is the same in a connection destination of the Z axis and a connection destination of the X axis.

In the present embodiment, when three calculators 10 are connected in a row for each coordinate axis, the connection port extending in the positive direction of the calculator 10 at both ends of the row is connected to the connection port extending in the negative direction thereof. Thus, the calculator 10 according to the present embodiment is connected in a torus shape by a path representing the X axis, a path representing the Y axis, and a path representing the Z axis.

The state of a torus-shaped connection corresponds to an example of a state of “a ring-shaped connection.” Further, the path representing the X axis corresponds to an example of a “first path,” the path representing the Y axis corresponds to an example of a “third path,” and the path representing the Z axis corresponds to an example of a “second path.” In addition, when viewed from the specific calculator 10, the other calculator 10 connected by the path representing the X axis and the path representing the Z axis corresponds to an example of a “first plurality of other arithmetic processing apparatuses” for the specific calculator 10. When viewed from the specific calculator 10, the other calculator 10 connected by the path representing the Y axis corresponds to an example of a “second plurality of arithmetic processing apparatuses” for the specific calculator 10.

As illustrated in FIG. 1, the nine calculators 10 are connected by the paths 151 to 153 which connect the three calculators 10 in a row. Path 151 represents the X axis. Further, path 152 represents the Y axis. Path 153 also represents the Z axis.

As described above, the connection destination of the connection port representing the Z axis and the connection destination of the connection port representing the X axis in each calculator 10 are the same calculator 10. The structure of the connection port, which represents the same coordinate axis as the connection ports representing the X axis and the Z axis, is referred to as a “multi-port structure.”

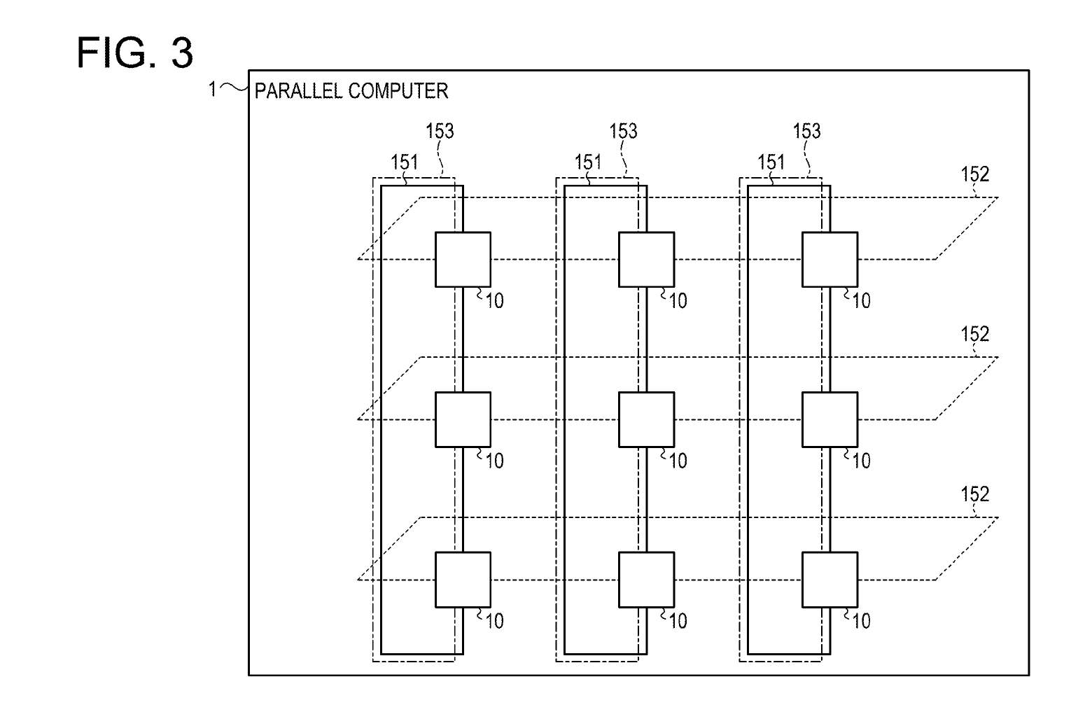

The path 151 corresponding to the X axis and the path 153 corresponding to the Z axis in this case may be referred to as a path representing the same coordinate axes as illustrated in FIG. 3. FIG. 3 is a diagram illustrating a state in which coordinate axes are integrated when a multi-port structure is provided. Thus, in this case, the path in the direction of the coordinate axis corresponding to paths 151 and 153 has twice the bus width. That is, a connection port having a multi-port structure is a connection port that multiplexes one coordinate axis.

In addition, each calculator 10 is assigned a coordinate represented by a value on each coordinate axis. In the following description, a coordinate represented by the value on the coordinate axis generated by connecting each connection port is referred to as a “connection port coordinate.” The connection port coordinate of the calculator 10 according to the present embodiment is a three-dimensional coordinate, and is represented in the form of (X, Y, Z).

Specifically, the connection port coordinate of each calculator 10 is determined by the following procedure. First, the calculator 10 is selected as a reference among the connection port coordinates. Then, the connection port coordinate of the reference calculator 10 becomes (0, 0, 0). The value incremented by one every time the X axis of the path 151 connected to the reference calculator 10 moves in the positive direction of the X axis becomes a value of the X axis of the connection port coordinate of the calculator 10 on the path 151 connected to the reference calculator 10. However, when the calculator 10 proceeds to the positive direction of the path 151 and returns to the reference calculator 10, assignment of the value of the X axis of the connection port coordinates of the calculator 10 on the path 151 connected to the reference calculator 10 is completed. In each calculator 10 to which the value of the X axis is assigned, the same value as the coordinate value of the X axis is assigned as the value of the coordinate of the Z axis indicated by the connection port representing the X axis and the connection port having the multi-port structure. Thus, the value of the Z axis of the connection port coordinate of the calculator 10 on the path 153 connected to the reference calculator 10 is assigned. In addition, the value of the Y axis of the calculator 10 on the paths 151 and 153 connected to the reference calculator 10 becomes zero which is the same as that of the reference calculator 10.

Further, the value of the Y axis of the connection port coordinate of the calculator 10 on the path 152 connected to the reference calculator 10 is set to a value that increases by one every time the calculator 10 moves in the positive direction of the Y axis in the path 152 connected to the reference calculator 10. However, when the calculator 10 proceeds to the positive direction of the path 152 and returns to the reference calculator 10, assignment of the value of the X axis of the connection port coordinates of the calculator 10 on the path 152 connected to the reference calculator 10 is completed. In addition, the values of the X and Y axes of the connection port coordinates of the calculator 10 on the path 152 connected to the reference calculator 10 become zero which is the same as that of the reference calculator 10.

In addition, the connection port coordinates obtained by incrementing the value of the Y axis one by one every time the calculator 10 moves from the calculator 10 on the paths 151 and 153 connected to the reference calculator 10 in the positive direction of the Y axis become the connection port coordinates of the calculator 10 at each position. Thus, the connection port coordinates assigned to the respective calculators 10 illustrated in FIG. 1 are assigned to the respective calculators 10.

That is, the connection port coordinates which are in an ascending order in one direction for each of the paths 151 to 153 and in which the values of the plurality of coordinates represented by the connection ports having the multi-port structure are set to the same value are assigned to the respective calculators 10. Then, the connection port coordinates assigned to each of the calculators 10 become the addresses of the respective calculators 10. An X coordinate in the connection port coordinates at this address corresponds to an example of “first positional information,” a Y coordinate corresponds to an example of “third positional information,” and a Z coordinate corresponds to an example of “second positional information.” Further, in the present embodiment, the fact that the X coordinate and the Z coordinate, which are the coordinates indicated by the connection ports having the multi-port structure have the same value, corresponds to an example that “the first positional information and the second positional information are identical.”

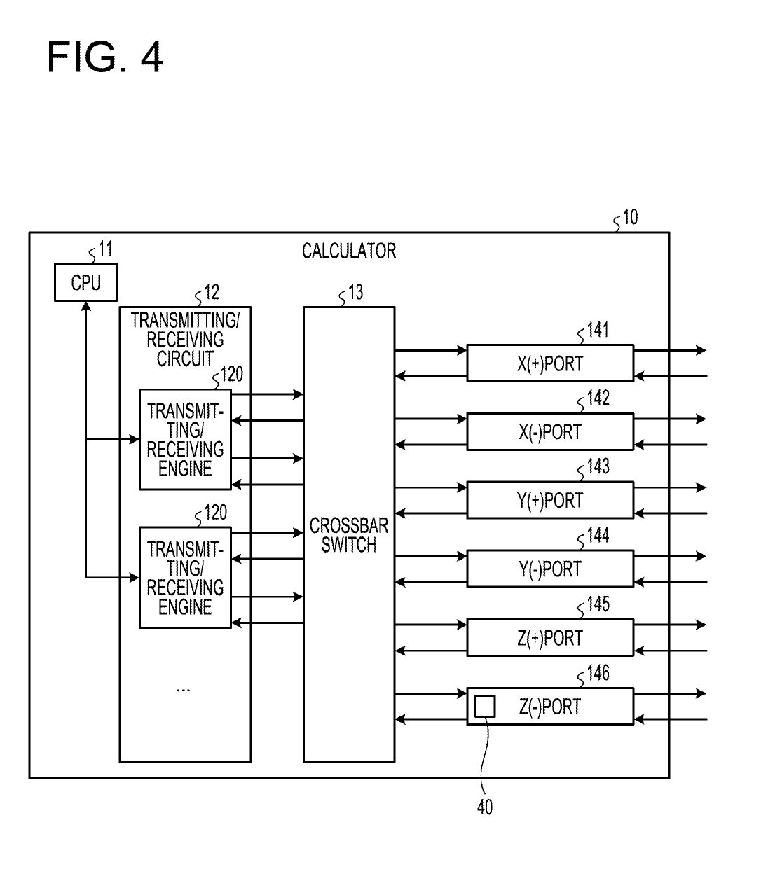

In addition, the calculator 10 has the configuration illustrated in FIG. 4. FIG. 4 is a block diagram of the calculator. The calculator 10 includes a central processing unit (CPU) 11, a transmitting/receiving circuit 12, a crossbar switch 13, and connection ports 141 to 146. The transmitting/receiving circuit 12 also includes a plurality of transmitting/receiving engines 120.

The CPU 11 serving as a processing device or a processor determines a destination of a packet. Then, the CPU 11 selects an empty transmitting/receiving engine 120. Thereafter, the CPU 11 designates a destination address and outputs the packet to the selected transmitting/receiving engine 120.

In addition, the CPU 11 receives an input of a packet transmitted from the other calculator 10 which designates the own device as a destination address from the transmitting/receiving engine 120. The CPU 11 then performs a process using the acquired packet.

The transmitting/receiving engine 120 receives the input of the packet to be transmitted from the CPU 11 together with the destination address. The transmitting/receiving engine 120 then determines whether the acquired packet is a packet for which an order guarantee is requested.

When the acquired packet is a packet for which an order guarantee is requested, the transmitting/receiving engine 120 determines whether there is a preceding packet for which an order guarantee is requested for the acquired packet. When there is a preceding packet for which an order guarantee is requested for the acquired packet, the transmitting/receiving engine 120 sets a transmission route that has transmitted the preceding packet as the transmission route of the received packet. Then, the transmitting/receiving engine 120 outputs the packet to one of the connection ports 141 to 146 that have transmitted the preceding packet according to the transmission route.

When there is no preceding packet for which an order guarantee is requested for the acquired packet, the transmitting/receiving engine 120 determines the transmission route using the empty state of the connection port 140 and the destination address. Then, the transmitting/receiving engine 120 outputs the packet to the connection port 140 based on the determined transmitting/receiving route.

In the meantime, when no order guarantee is requested for the acquired packet, the transmitting/receiving engine 120 determines the transmission route using the empty state of the connection port 140 and the destination address. Thereafter, the transmitting/receiving engine 120 outputs the packet to any of the connection ports 141 to 146 via the crossbar switch 13 according to the determined transmission route.

In addition, the transmitting/receiving engine 120 receives the input of packets transmitted from the other calculator 10 which designates the own device as a destination address from the connection ports 141 to 146 via the crossbar switch 13. The transmitting/receiving engine 120 then outputs the acquired packet to the CPU 11. The transmitting/receiving engine 120 corresponds to an example of a “transmission/reception control circuit.”

The crossbar switch 13 is a switch that switches the connection path between the transmitting/receiving engine 120 and the connection ports 141 to 146. When a packet is transmitted/received, the crossbar switch 13 switches the connection path in response to an instruction from the transmitting/receiving engine 120.

The connection ports 141 to 146 are ports which connect the calculator 10 to another calculator 10. The connection port 141 is a port which is connected to the path extending in the positive direction of the X axis. In FIG. 4, the X(+) port is marked so that it is easy to understand that the port extends in the positive direction of the X axis. Further, the connection port 142 is a port which is connected to the path extending in the negative direction of the X axis. In FIG. 4, the connection port 142 is marked with the X(−) port so that it is easy to understand that the port extends in the negative direction of the X axis. Also, the connection port 143 is a port which is connected to the path extending in the positive direction of the Y axis. In FIG. 4, the connection port 143 is marked with the Y(+) port so that it is easy to understand that the port extends in the positive direction of the Y axis. Further, the connection port 144 is a port which is connected to the path extending in the negative direction of the Y axis. In FIG. 4, the connection port 144 is marked with the Y(−) port so that it is easy to understand that the port extends in the negative direction of the Y axis. Also, the connection port 145 is a port which is connected to the path extending in the positive direction of the Z axis. In FIG. 4, the connection port 145 is marked with the Z(+) port so that it is easy to understand that the port extends in the positive direction of the Z axis. In addition, the connection port 146 is a port which is connected to the path extending in the negative direction of the Z axis. In FIG. 4, the connection port 146 is marked with the Z(−) port so that it is easy to understand that the port extends in the negative direction of the Z axis. In the following description, when the connection ports 141 to 146 are not distinguished from each other, they are referred to as “connection port 140.”

Each of the connection ports 140 has a determination circuit 40. The determination circuit 40 stores the address of the calculator 10 on which the calculator 10 itself is mounted. Then, when the connection port 140 on which the connection port 140 itself is mounted receives the packet transmitted from another calculator 10, the determination circuit 40 acquires a destination address of the received packet. Then, the determination circuit 40 compares the acquired destination address with the address of the calculator 10 on which the calculator 10 itself is mounted. When the acquired destination address matches the address of the calculator 10 on which the calculator 10 itself is mounted, the determination circuit 40 outputs the received packet to the transmitting/receiving engine 120 via the crossbar switch 13. In addition, when the acquired destination address matches the address of the calculator 10 on which the calculator 10 itself is mounted, the determination circuit 40 determines the transmission route of the packet. Thereafter, the connection port 140 outputs the packet to any of the other connection ports 140 via the crossbar switch 13 according to the determined transmission route.

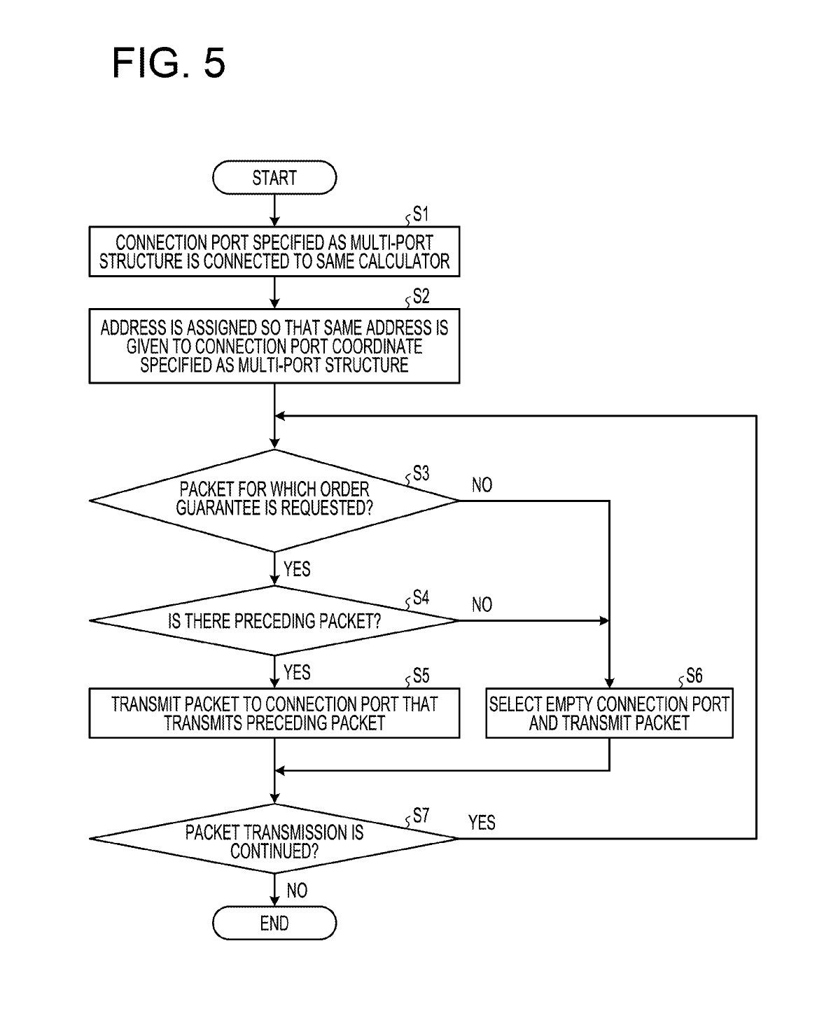

Next, the flow of a packet transmission process in the parallel computer 1 according to the present embodiment will be described with reference to FIG. 5. FIG. 5 is a flowchart of a transmission process of a packet by a parallel computer according to a first embodiment.

The connection port 140 specified as the multi-port structure of each calculator 10 is connected to the same other calculator 10 (step S1).

In addition, the connection port coordinates of each calculator 10 are determined such that the values of the coordinates to which the connection ports 140 specified as the multi-port structure of each calculator 10 are connected are the same. Then, the determined connection port coordinates are assigned to each calculator 10 as an address (step S2).

Thereafter, upon receiving a packet transmitted from the CPU 11, the transmitting/receiving engine 120 determines whether the acquired packet is a packet for which an order guarantee is requested (step S3).

When the acquired packet is a packet for which an order guarantee is requested (“YES” in step S3), the transmitting/receiving engine 120 determines whether there is a preceding packet for which an order guarantee is requested for the acquired packet (step S4). When there is the preceding packet (“YES” in step S4), the transmitting/receiving engine 120 determines that the same transmission route as the preceding packet is the transmission route of the acquired packet, and transmits the packet to the connection port 140 that has transmitted the preceding packet (step S5).

In the meantime, when the acquired packet is not a packet for which an order guarantee is requested (“NO” in step S3) or when there is no preceding packet in the acquired packet (“NO” in step S4), the transmitting/receiving engine 120 performs the following process. The transmitting/receiving engine 120 selects an empty connection port 140 among the connection ports 140 that are connected to the transmission route for sending the packet to the destination address. The transmitting/receiving engine 120 then transmits the packet to the selected connection port 140 (step S6).

Thereafter, the transmitting/receiving engine 120 determines whether to continue the transmission of the packet (step S7). When the transmission of the packet is continued (“YES” in step S7), the transmitting/receiving engine 120 returns to step S3.

When the transmission of the packet is terminated (“NO” in step S7), the transmitting/receiving engine 120 ends the transmission process of the packet.

As described above, in the present embodiment, each calculator of the parallel computer is connected so that the connection ports corresponding to different coordinate axes are connected to the same calculator, so that the connection port has a multi-port structure. The calculator is then given, as an address, the coordinate that has the same value on the coordinate axis corresponding to the connection port having the multi-port structure. This expands the bus with the calculator to which the connection port having the multi-port structure is connected. That is, by assigning a path to which connection ports having a multi-port structure are connected to a path on which communication is performed frequently, it is possible to speed up the bus that performs a frequent communication. Thus, the processing speed may be improved.

In addition, all paths to which connection ports having a multi-port structure are connected are represented by addresses having the same connection destination. Thus, one calculator may be represented by one address, so that the assignment of addresses may be easily performed. It is then possible to reduce the additional elements of the hardware and the processing of the software in transmitting the packet.

### Second Embodiment

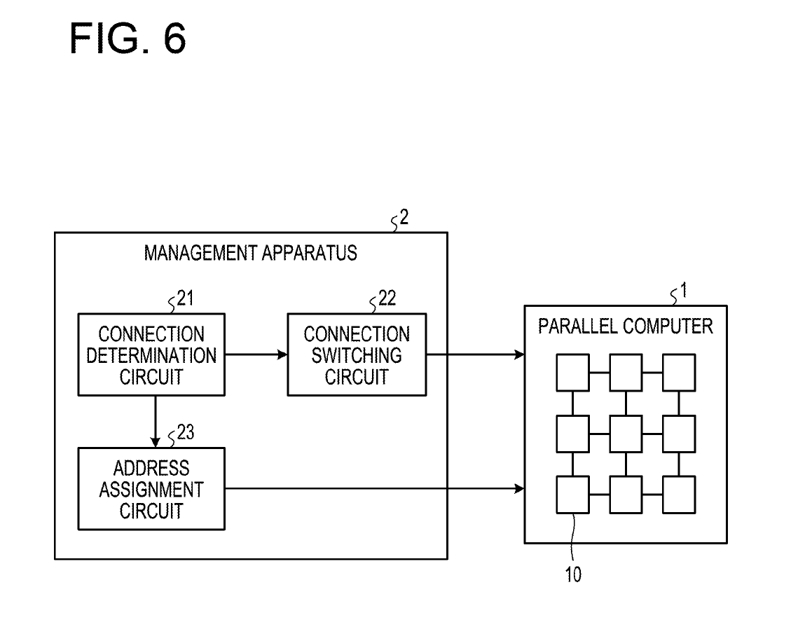

FIG. 6 is a block diagram of a management system of a parallel computer according to a second embodiment. The management system according to the present embodiment is different from the first embodiment in that the determination of the connection paths between the calculators 10 and assignment of the addresses is automatically performed. In the following description, the operation of each portion which is the same as that of the first embodiment will be omitted.

A management apparatus 2 is connected to the parallel computer 1. Here, in FIG. 6, the management apparatus 2 is a device different from the parallel computer 1, but the present disclosure is not limited thereto. For example, the management apparatus 2 may be arranged in the parallel computer 1 using any one of these calculators 10 of the parallel computer 1 as the management apparatus 2. The management apparatus 2 includes a connection determination circuit 21, a connection switching circuit 22, and an address assignment circuit 23.

The connection determination circuit 21 has information of the calculator 10 of the parallel computer 1. Then, the connection determination circuit 21 receives the input of the number of the calculators 10 on each coordinate axis. In addition, the connection determination circuit 21 receives the input of information on whether to expand the bus width and information on the bus width to be secured. Next, when the extension of the path width is specified, the connection determination circuit 21 selects the connection port 140 to be a multi-port structure so as to secure the specified bus width.

Then, the connection determination circuit 21 determines the calculator 10 to which each of the connection ports 140 of the respective calculators 10 is connected so that the connection port 140 having a multi-port structure is connected to the same calculator 10 and the number of the calculators 10 on the coordinate axis becomes a specified number. The connection determination circuit 21 then outputs the information of the connection destination of each of the connection ports 140 of the determined calculators 10 to the connection switching circuit 22 and the address assignment circuit 23.

The connection switching circuit 22 receives the input of the information of the connection destination of the connection port 140 of each calculator 10 from the connection determination circuit 21. Then, the connection switching circuit 22 switches connection between the calculators 10 so that the connection port 140 of each calculator 10 is connected to the specified calculator 10 of the connection destination.

The address assignment circuit 23 receives the input of the information of the connection destination of the connection port 140 of each calculator 10 from the connection determination circuit 21. The address assignment circuit 23 then determines the connection port coordinates of each calculator 10 so that the coordinate values on the coordinate axes indicated by the connection ports 140 having the multi-port structure in the respective calculators 10 coincide with each other. Then, the address assignment circuit 23 assigns the determined connection port coordinates to each calculator 10 as an address of each calculator 10.

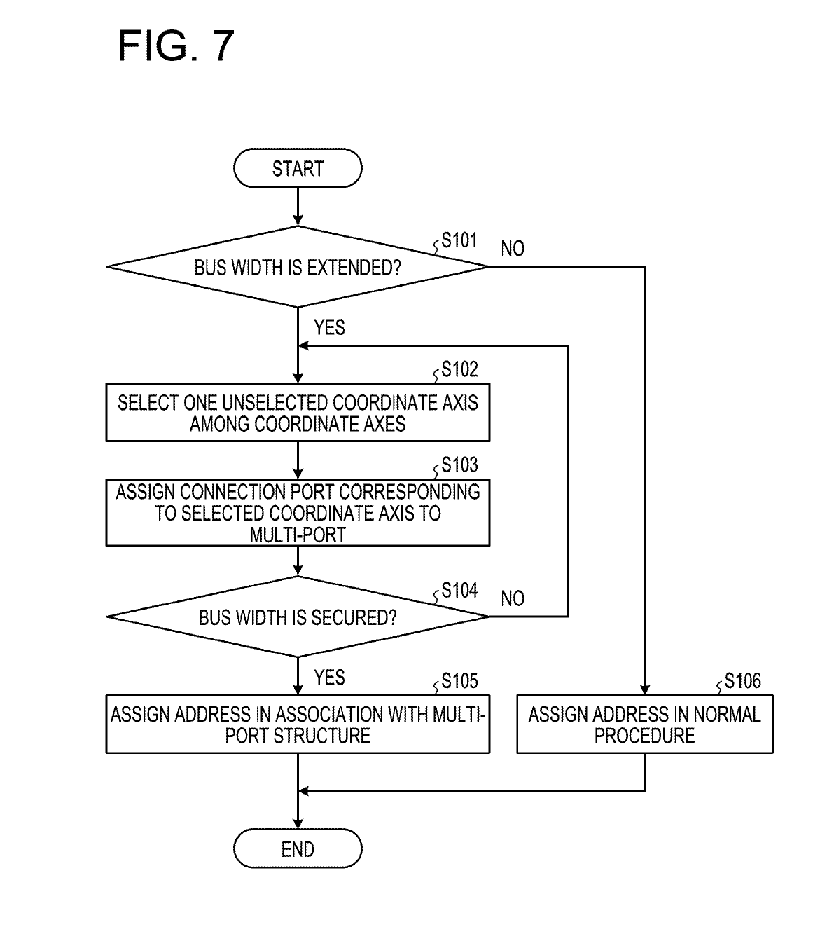

Next, a flow of the connection path determination process performed by the connection determination circuit 21 will be described with reference to FIG. 7. FIG. 7 is a flowchart of a process of determining a connection path.

The connection determination circuit 21 determines whether the bus width is to be extended depending on whether a designation of the path that extends the bus width has been received from the operator (step S101).

When the bus width is to be expanded (“YES” in step S101), the connection determination circuit 21 selects one unselected coordinate axis from the coordinate axes (step S102).

Next, the connection determination circuit 21 assigns the connection port 140 corresponding to the selected coordinate axis to the port having the multi-port structure (step S103).

Next, the connection determination circuit 21 determines whether the bus width of the path integrating the connection port 140 assigned as the port having the multi-port structure may secure the specified bus width (step S104). When the bus width has not yet been secured (“NO” in step S104), the connection determination circuit 21 returns to step S102.

When the bus width may be secured (“YES” in step S104), the connection determination circuit 21 assigns the address to the calculator 10 in association with the multi-port structure (step S105).

In the meantime, when the bus width is not extended (“NO” in step S101), the connection determination circuit 21 assigns the address in a normal procedure (step S106). That is, the connection determination circuit 21 connects the calculator 10 so that the connection ports 140 of each calculator 10 correspond to the respectively different coordinate axes.

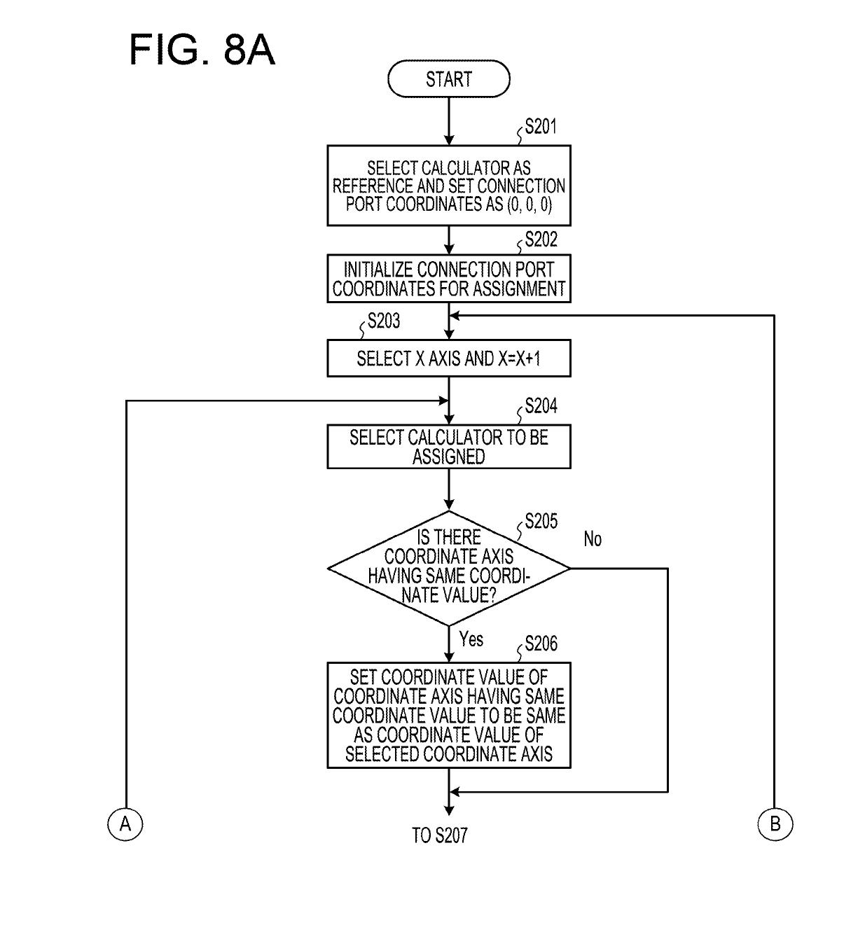

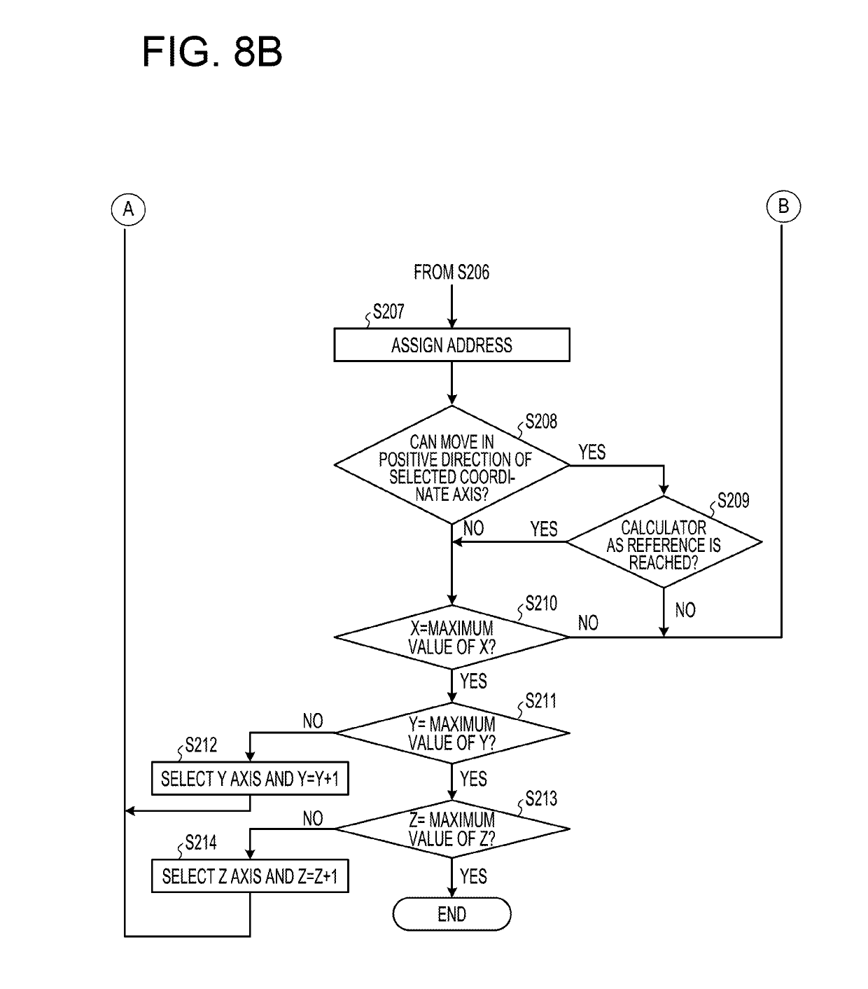

Next, the flow of the address assignment process to the calculator 10 by the address assignment circuit 23 will be described with reference to FIGS. 8A and 8B. FIGS. 8A and 8B are flowcharts of an address assignment process.

The address assignment circuit 23 selects the calculator 10 serving as a reference among the calculators 10 of the parallel computer 1. Then, the address assignment circuit 23 sets the connection port coordinates of the selected calculator 10 as (0, 0, 0) (step S201).

Next, the address assignment circuit 23 initializes the connection port coordinates for assignment (step S202). That is, the address assignment circuit 23 sets each coordinate of the connection port coordinates for assignment as X=0, Y=0, and Z=0.

Next, the address assignment circuit 23 selects the X axis as the selection axis and increments one X coordinate value of the connection port coordinates for assignment (step S203).

Next, the address assignment circuit 23 selects the calculator 10 at the position shifted by the number of coordinate values of the selected coordinate axes in the connection port coordinates for assignment in the positive direction of the selected coordinate axis as a target to be assigned (step S204).

Next, the address assignment circuit 23 determines whether there is a coordinate axis having the same coordinate value as the selected coordinate axis, depending on whether the connection port 140 corresponding to the selected coordinate axis in the calculator 10 to be assigned has a multi-port structure (step S205). When there is no coordinate axis having the same coordinate value (“NO” in step S205), the address assignment circuit 23 proceeds to step S207.

In the meantime, when there is a coordinate axis having the same coordinate value (“YES” in step S205), the address assignment circuit 23 sets the coordinate value of the coordinate axis having the same coordinate value as the selected coordinate axis in the connection port coordinate for assignment to the same value as the coordinate value of the selected coordinate axis (step S206).

Next, the address assignment circuit 23 sets the current connection port coordinates for assignment to the connection port coordinates of the calculator 10 to be assigned. Then, the address assignment circuit 23 assigns the connection port coordinates of the calculator 10 to be assigned as an address (step 207).

Next, the address assignment circuit 23 determines whether there is a coordinate axis which may move in the positive direction from the calculator 10 to be assigned (step S208).

When there is a coordinate axis which may move in the positive direction (“YES” in step S208), the address assignment circuit 23 determines whether the calculator 10 serving as a reference has been reached when moving from the calculator 10 to be assigned one by one in the X axis direction (step S209). When the calculator 10 serving as a reference has not been reached (“NO” in step S209), the address assignment circuit 23 returns to step S203.

In the meantime, when it is difficult to move in the positive direction of the selected coordinate axis (“NO” in step S208) and when the calculator 10 serving as a reference has been reached (“YES” in step S209), the address assignment circuit 23 determines whether the X coordinate of the connection port coordinate for assignment is the maximum value (step S210). When the X coordinate of the connection port coordinate for assignment is not the maximum value (“NO” in step S210), the address assignment circuit 23 returns to step S203.

When the X coordinate of the connection port coordinate for assignment is the maximum value (“YES” in step S210), the address assignment circuit 23 determines whether the Y coordinate of the connection port coordinate for assignment is the maximum value (step S211). When the Y coordinate of the connection port coordinate for assignment is not the maximum value (“NO” in step S211), the address assignment circuit 23 selects the Y axis as a selection axis, increments the Y coordinate value of the connection port coordinate for assignment by one (step S212), and the process returns to step S204.

When the Y coordinate of the connection port coordinate for assignment is the maximum value (“YES” in step S211), the address assignment circuit 23 determines whether the Z coordinate of the connection port coordinate for assignment is the maximum value (step S213). When the Z coordinate of the connection port coordinate for assignment is not the maximum value (“NO” in step S213), the address assignment circuit 23 selects the Z axis as a selection axis and increments the value of the Z coordinate of the connection port coordinate for assignment (step S214), and the process returns to step S204.

When the Z coordinate of the connection port coordinate for assignment is the maximum value (“YES” in step S213), the address assignment circuit 23 ends the address assignment process.

As described above, the calculator of the parallel computer according to the present embodiment is automatically connected so that the connection ports corresponding to different coordinate axes are connected to the same calculator, and the connection ports have a multi-port structure. In the calculator according to the present embodiment, the coordinates having the same value on coordinate axes corresponding to the connection ports having a multi-port structure are automatically given as an address. Thus, the bus width may be easily expanded. Further, in the inter-node connection having the multi-port structure, it is possible to reduce the number of additional elements of the hardware and the processing of the software in the packet transmission.

Here, in the present embodiment, a case of automatically performing the connection between the calculators 10 and the assignment of addresses has been described. However, a configuration may be employed in which addresses are automatically assigned to the calculators 10 connected in advance so as to have a multi-port structure. In this case as well, in the inter-node connection having the multi-port structure, it is possible to reduce the number of additional elements of the hardware and the processing of the software in the packet transmission.

### Third Embodiment

Hereinafter, a third embodiment will be described. The calculator in the parallel computer 1 according to the present embodiment is different from the first embodiment in that the transmitting/receiving engine 120 selects a port which outputs packets in accordance with the priority order. A block diagram of the calculator 10 according to the present embodiment is also illustrated in FIG. 4. In the following description, the operation of each portion which is the same as that of the first embodiment will not be described.

The CPU 11 determines whether an order guarantee is requested for the packet to be transmitted. In the case of a packet for which an order guarantee is requested, the CPU 11 determines whether there is a preceding packet which performs an order guarantee on the packet to be transmitted.

When there is a preceding packet, the CPU 11 selects the transmitting/receiving engine 120 that has transmitted the preceding packet. Then, the CPU 11 outputs the packet transmission command to the selected transmitting/receiving engine 120.

When there is no preceding packet, the CPU 11 selects an empty transmitting/receiving engine 120. Then, the CPU 11 outputs the packet transmission command to the selected transmitting/receiving engine 120.

Further, in the case of a packet for which an order guarantee is not requested, the CPU 11 selects the empty transmitting/receiving engine 120. Then, the CPU 11 outputs the packet transmission command to the selected transmitting/receiving engine 120.

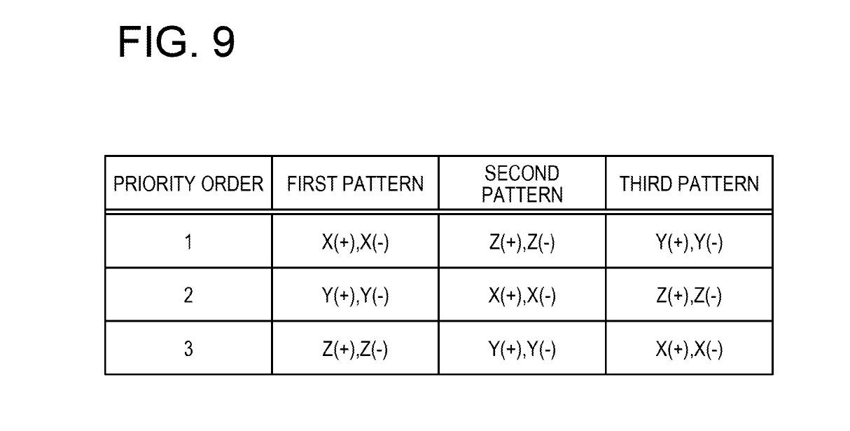

Each of the transmitting/receiving engines 120 has any of the priority order patterns illustrated in FIG. 9 in advance. FIG. 9 is a diagram illustrating a priority order pattern. For example, one transmitting/receiving engine 120 stores a first pattern as a priority order pattern. In addition, the other transmitting/receiving engine 120 stores a second pattern as a priority order pattern.

In FIG. 9, the connection port 140 is indicated by a coordinate axis. For example, the connection port 140 having the highest priority in the first pattern is the connection port 140 connected in the positive and negative directions of the X axis, and is the connection ports 141 and 142 in FIG. 4.

The transmitting/receiving engine 120 receives an input of a packet transmission command from the CPU 11. When the packet is a packet for which an order guarantee is requested, the transmitting/receiving engine 120 determines whether there is a preceding packet. When there is a preceding packet, the transmitting/receiving engine 120 determines transmitting the received packet using the same transmission route. The transmitting/receiving engine 120 then selects the connection port 140 that has transmitted the preceding packet as an output port. Then, the transmitting/receiving engine 120 transmits the received packet to the selected connection port 140.

In the meantime, when there is no preceding packet, or when the packet is not requested for order guarantee, the transmitting/receiving engine 120 performs the following process. The transmitting/receiving engine 120 specifies a route which transmits a packet to a destination address. Next, the transmitting/receiving engine 120 specifies empty connection ports 140 among the connection ports 140 that may pass through a specific route. Then, the transmitting/receiving engine 120 selects, as an output port, the connection port 140 which has the highest priority order in the own priority order pattern among the specified connection ports 140. Thereafter, the transmitting/receiving engine 120 transmits the packet to the selected connection port 140.

For example, descriptions will be made on a case where the transmitting/receiving engine 120 uses the first pattern among the output patterns illustrated in FIG. 9. When an order guarantee is not requested and all the connection ports 140 are empty, the transmitting/receiving engine 120 sets the connection port 141 or 142 in FIG. 4, which is the connection port 140 in the positive and negative directions of the X axis, as the output port. Further, when an order guarantee is not requested and the portion other than the connection port 140 in the positive and negative directions of the X axis is empty, the transmitting/receiving engine 120 sets, as the output port, the connection port 143 or 144 illustrated in FIG. 4, which is the connection port 140 in the positive and negative directions of the Y axis.

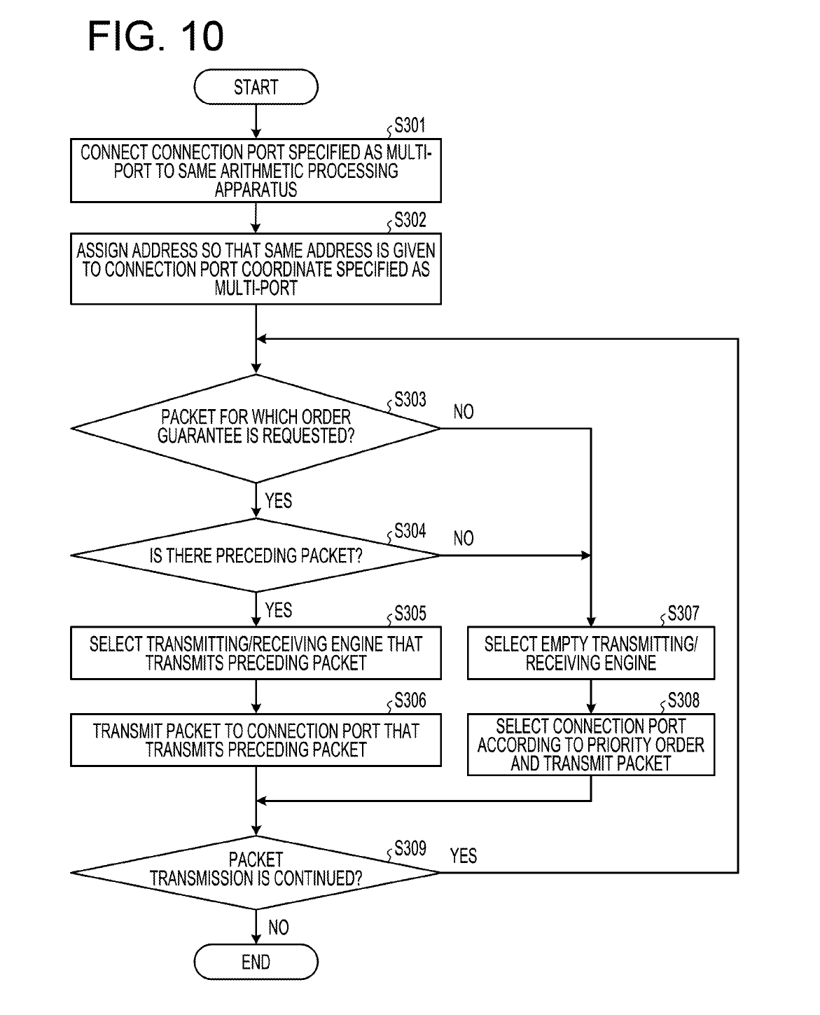

Next, the flow of the packet transmission process by the parallel computer 1 according to the present embodiment will be described with reference to FIG. 10. FIG. 10 is a flowchart of the packet transmission process by the parallel computer according to the third embodiment.

The connection port 140 specified as the multi-port structure of each calculator 10 is connected to the same other calculator 10 (step S301).

Further, the connection port coordinates of each calculator 10 are determined such that the values of the coordinates to which the connection ports 140 specified as the multi-port structure of each calculator 10 are connected are the same. Then, the determined connection port coordinates are assigned to the respective calculators 10 as addresses (step S302).

Thereafter, when the packet transmission is determined, the CPU 11 determines whether the packet to be transmitted is a packet for which an order guarantee is requested (step S303).

When the packet is a packet for which an order guarantee is requested (“YES” in step S303), the CPU 11 determines whether there is a preceding packet for which an order guarantee is requested for the packet to be transmitted (step S304).

When there is a preceding packet (“YES” in step S304), the CPU 11 selects the transmitting/receiving engine 120 that has transmitted the preceding packet (step S305). Then, the CPU 11 outputs a packet transmission command to the transmitting/receiving engine 120 that has transmitted the preceding packet.

The transmitting/receiving engine 120 receives an input of the packet transmission command from the CPU 11. Then, the transmitting/receiving engine 120 determines that the same transmission route as the preceding packet is the transmission route of the acquired packet, and transmits the packet to the connection port 140 that has transmitted the preceding packet (step S306).

In the meantime, when the acquired packet is not a packet for which an order guarantee is requested (“NO” in step S303) or when there is no preceding packet in the acquired packet (“NO” in step S304), the CPU 11 selects an empty transmitting/receiving engine 120. Then, the CPU 11 outputs a packet transmission command to the selected transmitting/receiving engine 120.

The transmitting/receiving engine 120 receives an input of the packet transmission command from the CPU 11. Then, the transmitting/receiving engine 120 selects the connection port 140 to be an output port in accordance with the destination address of the packet, the empty state of the connection port 140, and the priority order. The transmitting/receiving engine 120 then transmits the packet to the selected connection port 140 (step S308).

Thereafter, the transmitting/receiving engine 120 determines whether to continue the transmission of the packet (step S309). When the transmission of the packet is continued (“YES” in step S309), the transmitting/receiving engine 120 returns to step S303.

When the packet transmission is not continued but ends (“NO” in step S309), the transmitting/receiving engine 120 ends the packet transmission process.

As described above, in each calculator of the parallel computer according to the present embodiment, the transmitting/receiving engine selects the output port of the packet in accordance with the priority order. As a result, it is possible to preferentially select a path having a wide bus width, and the processing speed may be improved.

### Fourth Embodiment

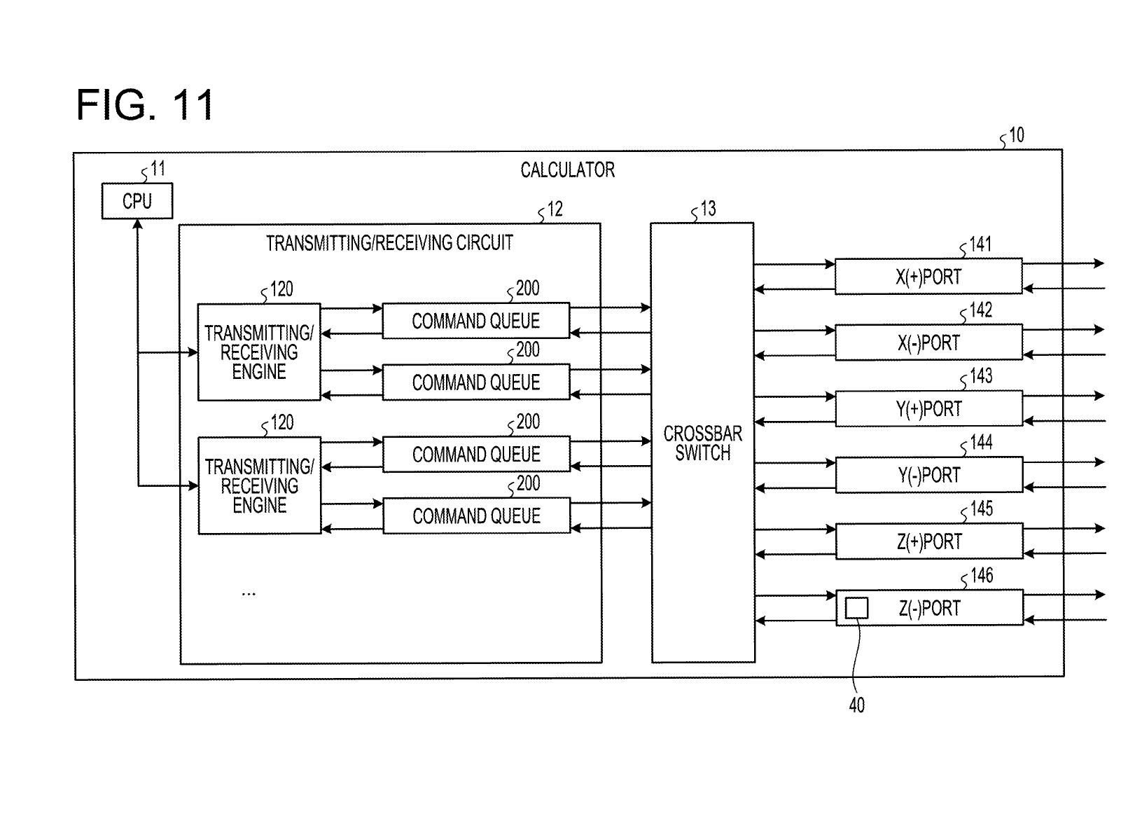

FIG. 11 is a block diagram of a calculator according to a fourth embodiment. The calculator 10 according to the present embodiment includes a plurality of command queues 200. The calculator 10 according to the present embodiment is different from the third embodiment in that the command queue 200 selects a port from which packets are output according to the priority order. In the following description, similarly to the third embodiment, the operation of each portion which is similar to that of the first embodiment will not be described.

The transmitting/receiving engine 120 receives a packet transmission command from the CPU 11. Then, the transmitting/receiving engine 120 determines whether the packet to be transmitted is a packet for which an order guarantee is requested. In the case of a packet for which an order guarantee is requested, the transmitting/receiving engine 120 determines whether there is a preceding packet which performs an order guarantee for the packet to be transmitted.

When there is a preceding packet, the transmitting/receiving engine 120 selects the command queue 200 that has transmitted the preceding packet. Then, the transmitting/receiving engine 120 outputs a packet transmission command to the selected command queue 200.

When there is no preceding packet, the transmitting/receiving engine 120 selects an empty command queue 200. Then, the transmitting/receiving engine 120 outputs a packet transmission command to the selected command queue 200.

In addition, in the case of a packet for which an order guarantee is not requested, the transmitting/receiving engine 120 selects an empty command queue 200. Then, the transmitting/receiving engine 120 outputs a packet transmission command to the selected command queue 200.

The command queue 200 is disposed between the transmitting/receiving engine 120 and the crossbar switch 13 so that a predetermined number corresponds to each transmitting/receiving engine 120. The command queue 200 stores commands such as transmission commands transmitted from the transmitting/receiving engine 120, and processes the commands in the order of the stored timings.

Packet transmission will be described in more detail. The command queue 200 has any one of the priority order patterns illustrated in FIG. 9 in advance. Then, the command queue 200 receives an input of the transmission command of the packet from the transmitting/receiving engine 120.

When the packet is a packet for which an order guarantee is requested, the command queue 200 determines whether there is a preceding packet. When there is a preceding packet, the command queue 200 determines to transmit the received packet using the same transmission route. Then, the command queue 200 selects the connection port 140 that has transmitted the preceding packet as the output port. The command queue 200 then transmits the packet received by the selected connection port 140.

When there is no preceding packet or when the packet is not requested for an order guarantee, the command queue 200 performs the following process. The command queue 200 specifies a route which transmits a packet to a destination address. Next, the command queue 200 specifies empty connection ports 140 among the connection ports 140 that may pass through a specific route. The command queue 200 selects, as an output port, the connection port 140 having the highest priority order in the own priority order pattern among the specified connection ports 140. Thereafter, the command queue 200 transmits the packet to the selected connection port 140.

For example, descriptions will be made on a case where the command queue 200 uses the second pattern among the patterns indicating the priority order illustrated in FIG. 9. When an order guarantee is not requested and all connection ports 140 are empty, the command queue 200 sets the connection port 145 or 146 illustrated in FIG. 11, which is the connection port 140 in the positive and negative directions of the Z axis, as the output port. Further, when an order guarantee is not requested and the portion other than the connection port 140 in the positive and negative directions of the Z axis is empty, the command queue 200 sets the connection port 141 or 142 illustrated in FIG. 11, which is the connection port 140 in the positive and negative directions of the Z axis, as the output port.

In addition, the command queue 200 acquires the packets transmitted from the other calculator 10 via the crossbar switch 13. The command queue 200 outputs the packets to the transmitting/receiving engine 120 in order of acquisition while adjusting the transmission timings of the packets with the command queue 200 connected to the same transmitting/receiving engine 120. This command queue 200 corresponds to an example of a “temporary holding circuit.”

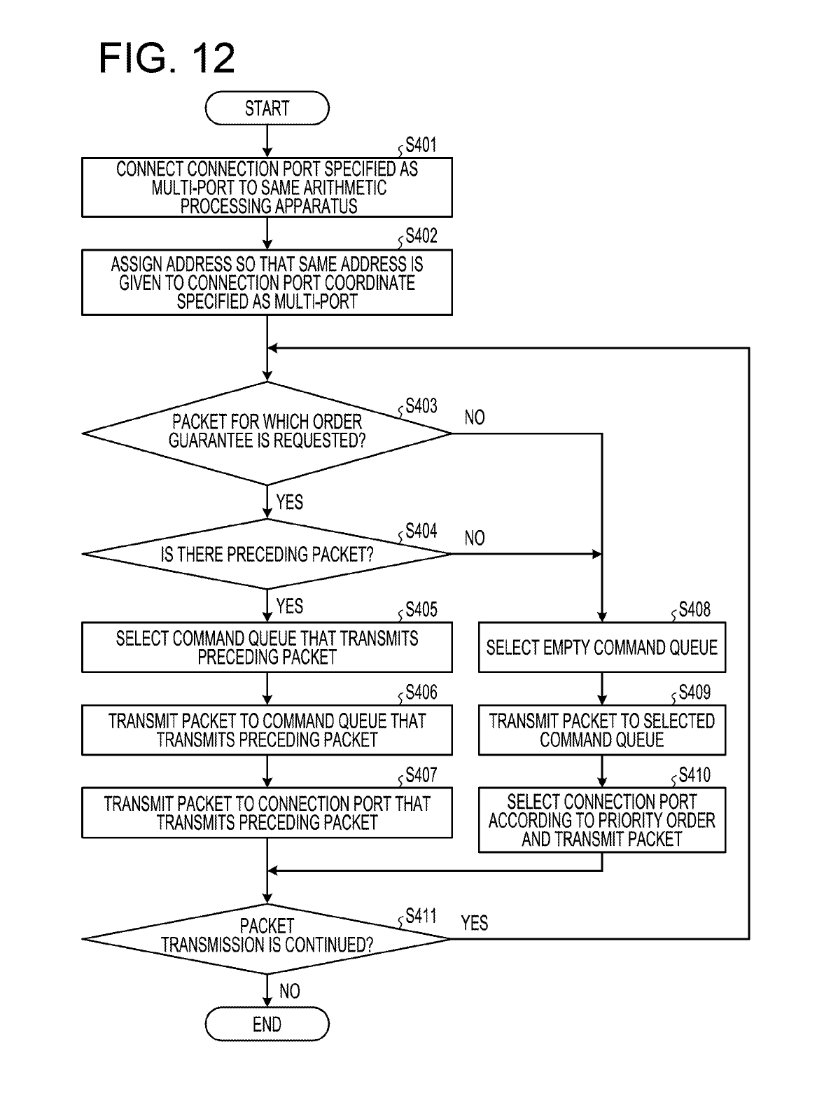

Next, the flow of the packet transmission process by the parallel computer 1 according to the present embodiment will be described with reference to FIG. 12. FIG. 12 is a flowchart of a packet transmission process by the parallel computer according to the fourth embodiment.

The connection port 140 specified as the multi-port structure of each calculator 10 is connected to the same other calculator 10 (step S401).

The connection port coordinates of each calculator 10 are determined such that the values of the coordinates to which the connection ports 140 specified as the multi-port structure of each calculator 10 are connected are the same. Then, the determined connection port coordinates are assigned to the respective computers 10 as addresses (step S402).

Thereafter, upon receiving the input of the packet transmitted from the CPU 11, the transmitting/receiving engine 120 determines whether the acquired packet is a packet for which an order guarantee is requested (step S403).

In the case of a packet for which an order guarantee is requested (“YES” in step S403), the transmitting/receiving engine 120 determines whether there is a preceding packet for which an order guarantee is requested for the acquired packet (step S404).

When there is a preceding packet (“YES” in step S404), the transmitting/receiving engine 120 selects the command queue 200 that has transmitted the preceding packet (step S405).

Then, the transmitting/receiving engine 120 transmits a packet transmission command to the command queue 200 that has transmitted the preceding packet (step S406).

The command queue 200 receives an input of a packet transmission command from the transmitting/receiving engine 120. Then, the command queue 200 transmits the packet to the same connection port 140 as the connection port 140 that has transmitted the preceding packet (step S407).

In the meantime, when the acquired packet is not a packet for which an order guarantee is requested (“NO” in step S403) or when there is no preceding packet in the acquired packet (“NO” in step S404), the transmitting/receiving engine 120 performs the following process. The transmitting/receiving engine 120 selects an empty command queue 200 (step S408).

Then, the transmitting/receiving engine 120 transmits a packet transmission command to the selected command queue 200 (step S409).

The command queue 200 receives an input of a packet transmission command from the transmitting/receiving engine 120. Then, the command queue 200 selects the connection port 140 to be an output port in accordance with the empty state and priority order of the connection port 140. The command queue 200 then transmits the packet to the selected access port 140 (step S410).

Thereafter, the transmitting/receiving engine 120 determines whether to continue the transmission of the packet (step S411). When the transmission of the packet is continued (“YES” in step S411), the transmitting/receiving engine 120 returns to step S403.

When the packet transmission is ended without connection (“NO” in step S411), the transmitting/receiving engine 120 ends the packet transmission process.

As described above, each of the calculators in the parallel computer according to the present embodiment selects the output port of the packet in accordance with the priority order of the command queue. As a result, it is possible to preferentially select a path having a wide bus width, and the processing speed may be improved. In addition, in general, the setting register of each command queue may often be a bit difference of the same address. Therefore, the command queue corresponding to each transmitting/receiving engine may have the same setting by storing the same value in the setting register. From this, the setting of the priority order for the command queue may be performed collectively by broadcasting. Therefore, compared with the case where the priority order is determined by the transmitting/receiving engine, the cost and time required to rewrite the priority order may be reduced.

FIG. 11 is used in the description of the present embodiment in which the output port is selected according to the priority order by the command queue. However, even the configuration of FIG. 11 may cause the transmitting/receiving engine 120 to select the output port according to the priority order as in the third embodiment.

### Fifth Embodiment

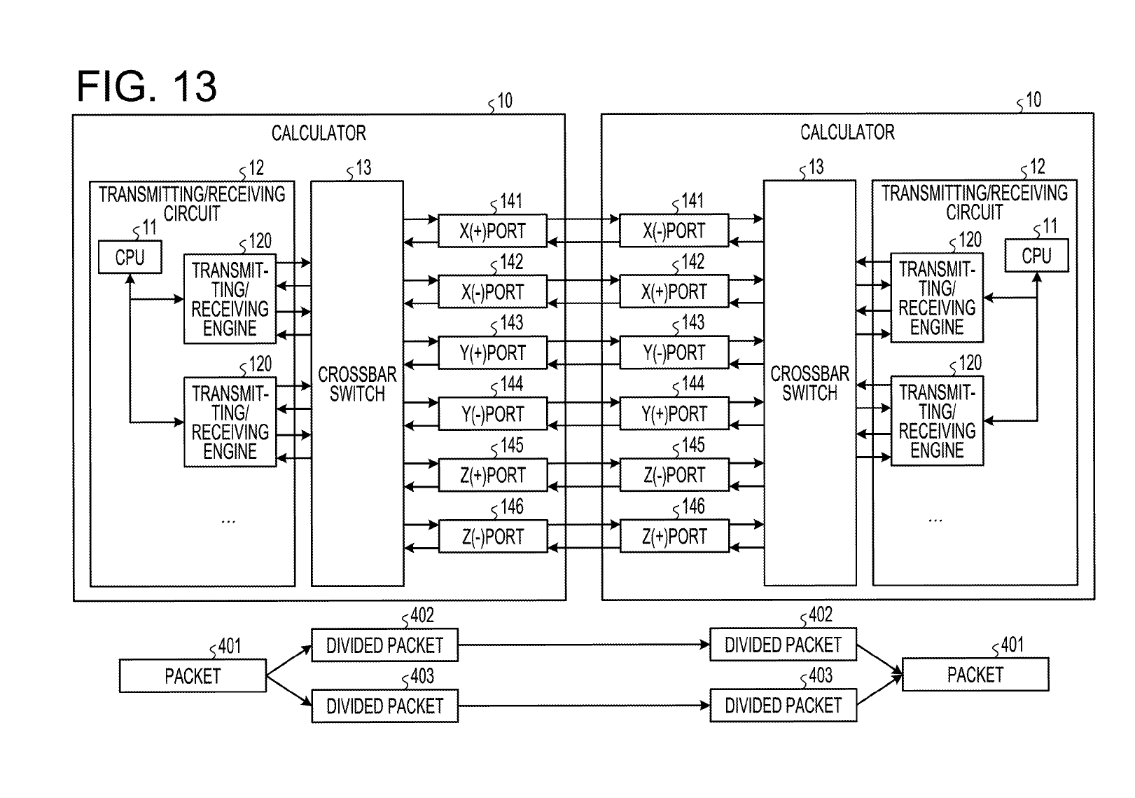

FIG. 13 is a diagram for explaining the transmission and reception of the packets in a parallel computer according to a fifth embodiment. The calculator 10 according to the present embodiment is different from the first embodiment in that packets are divided and the divided packets are transmitted using each of the connection ports 140 having a multi-port structure. In the following description, similarly to the third embodiment, the operation of each portion which is similar to that of the first embodiment will not be described.

In FIG. 13, the packets 401 and the divided packets 402 and 403 described below the calculator 10 toward the ground indicate the state of the packets when the divided packets are transmitted between the calculators 10. Here, in the present embodiment, descriptions will be made on a case where the connection ports 141 and 142 and the connection ports 145 and 146 corresponding to the X and Z axes have a multi-port structure.

The transmitting/receiving engine 120 receives from the CPU 11 a packet transmission command directed to the calculator 10 connected to the connection port 140 connected in the positive direction of the X and Z axes. Here, as an example, descriptions will be made on a case where the packets 401 are transmitted in the positive direction of the X and Z axes. When transmitting the packets 401 toward the calculator 10 connected to the connection port 140 having the multi-port structure, the transmitting/receiving engine 120 divides the packets 401 and generates divided packets 402 and 403.

The transmitting/receiving engine 120 determines to transmit the divided packets 402 to the other calculator 10 using the connection port 141 connected in the positive direction of the X axis. Further, the transmitting/receiving engine 120 determines to transmit the divided packets 403 to the other calculator 10 using the connection port 145 connected in the positive direction of the X axis. Thereafter, the transmitting/receiving engine 120 outputs the divided packets 402 from the connection port 141 and outputs the divided packets 403 from the connection port 145.

The transmitting/receiving engine 120 of the calculator 10 on the receiving side receives the input of the divided packets 402 via the connection port 142 connected in the negative direction of the X axis. Further, the transmitting/receiving engine 120 of the calculator 10 on the receiving side receives the input of the divided packets 403 via the connection port 146 connected in the negative direction of the Z axis.

The transmitting/receiving engine 120 of the calculator 10 on the receiving side combines the divided packets 402 and the divided packets 403 to generate the original packets 401. Then, the transmitting/receiving engine 120 outputs the generated packets 401 to the CPU 11.

In addition, as illustrated in FIG. 13, a case of a communication between the calculators 10 directly connected to each other has been described here. However, even when a communication is performed via another calculator 10, the calculator 10 may transmit and receive the divided packets 402 and 403 in the same manner.

As described above, in the calculator according to the present embodiment, when packets are transmitted using a connection port having a multi-port structure, the calculator on the transmitting side divides and transmits the packets, and the calculator on the receiving side combines the received packets to return the packets to the original packets. Thus, since the bus width may be effectively used, the communication efficiency and the processing speed may be improved.

Further, in each of the above embodiments, a case has been described in which the two-dimensional connection port of the calculator having three-dimensional connection port coordinates is set as a multi-port structure, but the connection of the multi-port structure is not limited to this. For example, in the calculator having three-dimensional connection port coordinates, the three-dimensional connection port may be set as a multi-port structure. In a calculator having three or more dimensional connection port coordinates, it is also possible to multiply the connection ports by any number equal to or smaller than the dimension, thereby forming a multi-port structure. For example, in a calculator having six-dimensional connection port coordinates, it is also possible to set each of two coordinates as a multi-port structure.

Further, in each of the above embodiments, a case has been described in which each of the calculators is connected in a torus shape (ring shape). However, the network configuration in which the processing speed is improved in the communication using the connection port having the multi-port structure by using the functions described in each embodiment is not limited to this. For example, each path from the X axis to the Z axis may be a network configuration that connects each calculator in a series of connections and terminates at both ends of the calculator. In this way, the network configuration that connects each calculator in a series of connections and terminates at both ends of the calculator corresponds to a state of “connected in a row.”

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising
a plurality of arithmetic processing apparatuses, each of the plurality of arithmetic processing apparatuses is configured to:
be coupled to a first plurality of other arithmetic processing apparatuses among the plurality of arithmetic processing apparatuses via a first path and a second path,
be coupled to a second plurality of other arithmetic processing apparatuses among the plurality of arithmetic processing apparatuses via a third path,
include first positional information on the first path, second positional information on the second path, and positional information on the third path, and
perform a communication with the first plurality of other arithmetic processing apparatuses or the second plurality of other arithmetic processing apparatuses using address information in which the first positional information and the second positional information corresponding to each of the first plurality of other arithmetic processing apparatuses are identical.

2. The information processing apparatus according to claim 1, further comprising:
a management apparatus configured to assign the address information to each of the plurality of arithmetic processing apparatuses.

3. The information processing apparatus according to claim 1, wherein each of the plurality of arithmetic processing apparatuses is coupled to the first plurality of other arithmetic processing apparatuses in a row via the first path and the second path.

4. The information processing apparatus according to claim 1, wherein each of the plurality of arithmetic processing apparatuses is coupled to the first plurality of other arithmetic processing apparatuses in a ring shape via the first path and the second path.

5. The information processing apparatus according to claim 1, wherein each of the plurality of arithmetic processing apparatuses includes:
information on a priority order of the first path, the second path, and the third path, and
a transmitting/receiving control circuit configured to:
select a communication path among the first path, the second path, and the third path according to the priority order, and
perform transmitting/receiving a packet using the selected communication path.

6. The information processing apparatus according to claim 1, wherein each of the arithmetic processing apparatuses includes:
a transmitting/receiving control circuit configured to perform transmitting/receiving a packet to/from the first plurality of other arithmetic processing apparatuses or the second plurality of other arithmetic processing apparatuses via the first path, the second path, or the third path; and
a temporary holding circuit configured to:
include a priority order of the first path, the second path, or the third path,
hold the packet transmitted by the transmitting/receiving control circuit,
determine a communication path among the first path, the second path, and the third path according to the priority order, and
output the packet to the communication path determined according to an order received from the transmitting/receiving control circuit.

7. A plurality of arithmetic processing apparatuses included in an information processing apparatus, wherein each of the plurality of arithmetic processing apparatuses is configured to:
be coupled to a first plurality of other arithmetic processing apparatuses among the plurality of arithmetic processing apparatuses via a first path and a second path,
be coupled to a second plurality of other arithmetic processing apparatuses among the plurality of arithmetic processing apparatuses via a third path,
include first positional information on the first path, second positional information on the second path, and positional information on the third path, and
perform a communication with the first plurality of other arithmetic processing apparatuses or the second plurality of other arithmetic processing apparatuses using address information in which the first positional information and the second positional information corresponding to each of the first plurality of other arithmetic processing apparatuses are identical.

8. The plurality of arithmetic processing apparatuses according to claim 7, wherein each of the plurality of arithmetic processing apparatuses is coupled to the first plurality of other arithmetic processing apparatuses in a row via the first path and the second path.

9. The plurality of arithmetic processing apparatuses according to claim 7, wherein each of the plurality of arithmetic processing apparatuses is coupled to the first plurality of other arithmetic processing apparatuses in a ring shape via the first path and the second path.

10. The plurality of arithmetic processing apparatuses according to claim 7, wherein each of the plurality of arithmetic processing apparatuses includes:
information on a priority order of the first path, the second path, and the third path, and
a transmitting/receiving control circuit configured to:
select a communication path among the first path, the second path, and the third path according to the priority order, and
perform transmitting/receiving a packet using the selected communication path.

11. A control method for an information processing apparatus including a plurality of arithmetic processing apparatuses, each of the plurality of arithmetic processing apparatuses being coupled to a first plurality of other arithmetic processing apparatuses among the plurality of arithmetic processing apparatuses via a first path and a second path, and being coupled to a second plurality of other arithmetic processing apparatuses among the plurality of arithmetic processing apparatuses via a third path, each of the plurality of arithmetic processing apparatuses including first positional information on the first path, second positional information on the second path, and positional information on the third path, the control method comprising:
assigning, to each of the plurality of arithmetic processing apparatuses, address information in which the first positional information and the second positional information corresponding to each of the first plurality of other arithmetic processing apparatuses are identical; and
performing, by each of the plurality of arithmetic processing apparatuses, a communication with the first plurality of other arithmetic processing apparatuses or the second plurality of other arithmetic processing apparatuses using the assigned address information.

12. The control method according to claim 11, wherein each of the plurality of arithmetic processing apparatuses is coupled to the first plurality of other arithmetic processing apparatuses in a row via the first path and the second path.

13. The control method according to claim 11, wherein each of the plurality arithmetic processing apparatuses is coupled to the first plurality of other arithmetic processing apparatuses in a ring shape via the first path and the second path.

14. The control method according to claim 11, wherein each of the plurality of arithmetic processing apparatuses includes:
information on a priority order of the first path, the second path, and the third path, and
a transmitting/receiving control circuit configured to:
select a communication path among the first path, the second path, and the third path according to the priority order, and
perform transmitting/receiving a packet using the selected communication path.
